(19) United States
(12) Patent Application Publication
(10) Pub. No.: US 2026/0133079 A1
(43) Pub. Date: May 14, 2026

(54) ACTIVATABLE DUAL THERMAL INDICATORS

(71) Applicant: Zebra Technologies Corporation, Lincolnshire, IL (US)

(72) Inventors: Brian S. Huffman, Belle Mead, NJ (US); Sean MacDavitt, Locust Valley, NY (US); Mohannad Abdo, Clifton, NJ (US)

(73) Assignee: Zebra Technologies Corporation, Lincolnshire, IL (US)

(21) Appl. No.: 18/947,236

(22) Filed: Nov. 14, 2024

(51) Int. Cl. G01K 11/06

(52) U.S. Cl. CPC G01K 11/06

(57) ABSTRACT

Activatable dual thermal indicators are disclosed herein. An example is provided by an activatable environmental exposure indicator, including: a substrate, a cover layer overlaying the substrate, a first reservoir and a second reservoir, separately disposed between the substrate and the cover layer and within in an activation region, a first plurality of microcapsules disposed in the first reservoir, each microcapsule of the first plurality of microcapsules including a first payload microencapsulated in a first frangible shell, a second plurality of microcapsules disposed in the second reservoir, each microcapsule of the second plurality of microcapsules including a second payload microencapsulated in a second frangible shell. The second payload includes a second liquefiable material configured to liquefy responsive to a second predetermined environmental exposure.

### BACKGROUND

Environmental indicators may be configured to indicate the occurrence of an environmental exposure to a host product. Prior to the association between the host product and the indicator, the same level of care must often be paid to the indicator to prevent an exposure to the environmental condition which the indicator is configured to indicate, so that the indicator is not triggered prematurely and rendered unusable for use with the host product. For example, high temperature exposure indicators may need to be kept in deep freeze or refrigerated conditions, complicating the component supply chains for the products they are used with. Activatable environmental indicators have been previously proposed.

### SUMMARY

In a first embodiment, the technology of the present disclosure is provided by an activatable environmental exposure indicator, including: a substrate, a cover layer overlaying the substrate, a first reservoir and a second reservoir, separately disposed between the substrate and the cover layer and within in an activation region, a first plurality of microcapsules disposed in the first reservoir, each microcapsule of the first plurality of microcapsules including a first payload microencapsulated in a first frangible shell. The first payload includes a first liquefiable material configured to liquefy responsive to a first predetermined environmental exposure. The first frangible shells are configured to rupture responsive to an application of an activation action, releasing the first payload from the first frangible shells, and wherein the first payload is configured to produce a first observable effect in a first indicator region responsive to the first liquefiable material being liquefied after the first payload is released from the frangible shells. The first frangible shells are configured to block the first payload from producing the first observable effect in the first indicator region prior to the application of the activation action. The activatable environmental exposure indicator further includes a second plurality of microcapsules disposed in the second reservoir, each microcapsule of the second plurality of microcapsules including a second payload microencapsulated in a second frangible shell. The second payload includes a second liquefiable material configured to liquefy responsive to a second predetermined environmental exposure. The second frangible shells are configured to rupture responsive to the application of the activation action, releasing the second payload from the second frangible shells, and wherein the second payload is configured to produce a second observable effect in a second indicator region after the second payload is released from the second frangible shells and when the second liquefiable material is liquefied. The second frangible shells are configured to block the second payload from producing the second observable effect in the second indicator region prior to the application of the activation action.

In a second embodiment, the technology of the present disclosure is provided by a thermal exposure indicator, including a substrate, a high temperature excursion indicator coupled to the substrate, including: an indicator region, a first plurality of microcapsules, each containing a first payload microencapsulated in a first frangible shell, the first payload including a first liquefiable material configured to liquefy when exposed to a temperature above a first predetermined high temperature threshold, wherein the first frangible shells are configured to rupture responsive to an application of an activation action, releasing the first payload, and wherein, after being released from the first frangible shells, the first payload is configured to produce an observable effect in the indicator region when liquefied, wherein, prior to the application of the activation action, the first frangible shells are configured to contain the first payload when the first liquefiable material is liquefied and when the first liquefiable material is not liquefied, such that the first payload is blocked from producing the observable effect in the indicator region even after an exposure to the temperature above the first predetermined high temperature threshold. The activatable environmental exposure indicator further includes a time-temperature indicator, coupled to the substrate including: a migration region, and a second plurality of microcapsules, each containing a second payload microencapsulated in a second frangible shell, the second payload including a second liquefiable material configured to liquefy when exposed to a temperature above a second predetermined high temperature threshold, and solidify when exposed to a temperature below the second predetermined high temperature threshold, wherein the second frangible shells are configured to rupture responsive to the application of the activation action, releasing the second payload, and wherein, after being released from the second frangible shells, the second payload is configured to migrate through the migration region when the second liquefiable material is liquefied, and to halt migration when the second liquefiable material is solidified, wherein, prior to the application of the activation action, the second frangible shells are configured to contain the second payload when the second liquefiable material is liquefied and when the second liquefiable material solidified, such that the second payload is blocked from migrating through the migration region even after an exposure to the temperature above the second predetermined high temperature threshold, and an activation region aligned with the first plurality of microcapsules and the second plurality of microcapsules, configured such that when a compressive force is applied to the activation region, the activation action is simultaneously applied to both the first plurality of microcapsules and the second plurality of microcapsules.

In an example aspect of the first and second embodiments, the first indicator region is connected to the first reservoir by a first migration region, configured to permit migration of the first payload from the first reservoir to the first indicator region when the first payload is released from the first frangible shells and the first liquefiable material is liquefied.

In an example aspect of the first and second embodiments, the second indicator region is connected to the second reservoir by a second migration region configured to permit migration of the second payload from the second reservoir to the second indicator region when the second payload is released from the second frangible shells and the second liquefiable material is liquefied.

In an example aspect of the first and second embodiments, at least one of the first migration region and the second migration region includes a wick.

In an example aspect of the first and second embodiments, the cover layer includes transparent portions, configured such that at least the first indicator region and the second indicator region are viewable through the cover layer.

In an example aspect of the first and second embodiments, the transparent portions are further configured such that at least a portion of at least one of the first migration region and the second migration region is viewable through the cover layer.

In an example aspect of the first and second embodiments, the first predetermined environmental exposure is an exposure to a temperature above a first predetermined temperature threshold, such that when the first payload is at a temperature above the first predetermined temperature threshold, the first liquefiable material is liquefied and the first payload migrates through the first migration region at a predetermined rate, and when the first payload is at a temperature below the first predetermined temperature threshold, the first liquefiable material is solidified, and the first payload halts migration through the first migration region, such that a distance through the first migration region which the first payload has migrated corresponds to an amount of time which the first payload has been at temperatures above the first predetermined temperature threshold.

In an example aspect of the first and second embodiments, the second predetermined environmental exposure is an exposure to a temperature above a second predetermined temperature threshold, such that when the second payload is at a temperature above the second predetermined temperature threshold, the second liquefiable material is liquefied and the second payload migrates through the second migration region at a predetermined rate, and when the second payload is at a temperature below the second predetermined temperature threshold, the second liquefiable material is solidified, and the second payload halts migration through the second migration region, such that a distance through the second migration region which the second payload has migrated corresponds to an amount of time which the second payload has been at temperatures above the second predetermined temperature threshold.

In an example aspect of the first and second embodiments, the first payload is configured to migrate into the first indicator region and produce the first observable effect responsive to a single exposure to the first predetermined environmental exposure occurring after the first frangible shells are ruptured responsive to the application of the activation action.

In an example aspect of the first and second embodiments, the second payload is configured to migrate into the second indicator region and produce the second observable effect responsive to a single exposure to the second predetermined environmental exposure occurring after the second frangible shells are ruptured responsive to the application of the activation action.

In an example aspect of the first and second embodiments, at least one of the substrate and the cover defines the first indicator region.

In an example aspect of the first and second embodiments, the first reservoir and the second reservoir are sealed between the substrate and the cover layer.

In an example aspect of the first and second embodiments, the first plurality of microcapsules and the second plurality of microcapsules are isolated from one another by a membrane, the membrane configured to isolate the first payload from the second payload when the first payload is released from the first frangible shells and second payload is released from the second frangible shells.

In an example aspect of the first and second embodiments, the first reservoir is between the substrate and the membrane, and the second reservoir is between the membrane and a cover layer.

In an example aspect of the first and second embodiments, the first reservoir is disposed on the substrate, and the second reservoir is disposed on the substrate adjacent to the first reservoir, and the membrane is disposed between the cover layer and the substrate in a configuration which isolates the first reservoir from the second reservoir.

In an example aspect of the first and second embodiments, the activation region includes a depressible portion aligned with both the first reservoir and the second reservoir.

In an example aspect of the first and second embodiments, the depressible portion is configured to transfer a compressive force to the first plurality of microcapsules and the second plurality of microcapsules such that at least a proportion of the first frangible shells are ruptured, releasing the first payload, and at least a proportion of the second frangible shells are ruptured, releasing the second payload.

In an example aspect of the first and second embodiments, the first plurality of microcapsules and the second plurality of microcapsules are configured to rupture in response to a compression force applied to the activation region with a predetermined activation threshold selected from a group consisting of: a compression stress exceeding 0.1 pounds per square inch (psi), a compression stress exceeding 0.5 psi, a compression stress exceeding 1 psi, a compression stress exceeding 2 psi, a compression stress exceeding 5 psi, a compression stress exceeding 10 psi, and a compression stress exceeding 15 psi.

In an example aspect of the first and second embodiments, the predetermined activation threshold for the first plurality of microcapsules and the second plurality of microcapsules is reduced in response to an application of heat.

In an example aspect of the first and second embodiments, the first predetermined environmental exposure and the second predetermined environmental exposure are selected from a group consisting of: a temperature excursion above a predetermined temperature threshold for at least a predetermined amount of time, temperature excursion below a predetermined temperature for at least a predetermined amount of time, cumulative exposure to temperature over a time period above a predetermined threshold for at least a predetermined amount of time, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, a predetermined electromagnetic exposure, a humidity exposure, an exposure to a humidity level above a predetermined threshold, and an exposure to a humidity level above a predetermined threshold for at least a predetermined amount of time.

In an example aspect of the first and second embodiments, the first liquefiable material and the second liquefiable material include materials selected from a group consisting of: a side-chain crystallizable polymer, an alkane, a wax, an alkane wax, esters, other polymeric materials, and combinations thereof.

In an example aspect of the first and second embodiments, the first payload includes a first indicator material combined with the first liquefiable material, the first indicator material configured to produce the first observable effect in the first indicator region responsive to the first liquefiable material liquefying after the first payload is released from the first frangible shells.

In an example aspect of the first and second embodiments, the second payload includes a second indicator material combined with the second liquefiable material, the second indicator material configured to produce the second observable effect in the second indicator region responsive to the second liquefiable material liquefying after the second payload is released from the second frangible shells.

In an example aspect of the first and second embodiments, the first predetermined environmental exposure is an exposure to a temperature above a first predetermined high temperature threshold, and the second predetermined environmental exposure is an exposure to a temperature above a second predetermined high temperature threshold, lower than the first predetermined high temperature threshold.

In an example aspect of the first and second embodiments, the second payload and the migration region are configured such that the second payload migrates at a predetermined rate along the migration region when the second liquefiable material is liquefied, such that a distance along the migration region through which the second payload has migrated corresponds to a cumulative duration of an exposures above the second predetermined high temperature threshold.

In an example aspect of the first and second embodiments, the first predetermined high temperature threshold is greater than the second predetermined high temperature threshold.

In an example aspect of the first and second embodiments, the activation action includes a compression stress with a predetermined activation threshold selected from a group consisting of: a stress exceeding 0.1 pounds per square inch (psi) a stress exceeding 0.5 psi, a stress exceeding 1 psi, a stress exceeding 2 psi, a stress exceeding 5 psi, a stress exceeding 10 psi, and a stress exceeding 15 psi.

In an example aspect of the first and second embodiments, the activation region includes a depressible portion configured such that when the depressible portion is depressed by the compressive force, the depressible portion transfers a compressive stress to the first plurality of microcapsules and the second plurality of microcapsules.

In an example aspect of the first and second embodiments, the first plurality of microcapsules is physically isolated from the second plurality of microcapsules by a membrane, such that when the first plurality of microcapsules is ruptured and the second plurality of microcapsules is ruptured, the first payload is blocked from contacting the migration region and the second payload is blocked from contacting the indicator region.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed technology and explain various principles and advantages of those embodiments.

FIG. 1 illustrates a microcapsule, according to embodiments of the present disclosure.

FIG. 2A illustrates a first embodiment of an activatable environmental exposure indicator, according to embodiments of the present disclosure.

FIG. 2B illustrates a second embodiment of an activatable environmental exposure indicator, according to embodiments of the present disclosure.

FIG. 2C illustrates a third embodiment of an activatable environmental exposure indicator, according to embodiments of the present disclosure.

FIG. 2D illustrates a fourth embodiment of an activatable environmental exposure indicator, according to embodiments of the present disclosure.

FIGS. 3A-3F illustrate various stages of activation of an example activatable environmental exposure indicator, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present technology.

The apparatus and method components have been represented where appropriate by conventional symbols in the drawings, showing only those specific details that are pertinent to understanding the embodiments of the present technology so as not to obscure the disclosure with details that will be readily apparent to those of ordinary skill in the art having the benefit of the description herein.

### DETAILED DESCRIPTION

The technology of the present disclosure is related to an activation platform for environmental indicators, such as peak temperature exposure and time-temperature indicators. Environmental indicators (e.g., indicators incorporating an indicator material that liquifies in response to a predetermined environmental exposure) may be configured to indicate the occurrence of such a predetermined environmental exposure to a host product, e.g., by changing appearance or by changing an electrical property of the indicator which may be detected by an appropriate circuit or computer. Prior to the association between the host product and the indicator, the same level of care must be paid to the indicator to prevent an exposure to the environmental condition of which the indicator is configured to indicate, such that the indicator is not spent prematurely and rendered unusable with the host product. Said differently, if a thermal indicator is to be installed on a host product, the indicator may need to be held below the temperature at which the thermal indicator is configured to indicate prior to installation of the indicator on or with a monitored host product. If a sufficient thermal exposure were to occur prior to pairing with the host product, the indicator would transition to an indicative state prior to installation, and, provided the indicator is an irreversible indicator, the indicator would be expended prior to use. For example, indicators configured for use with refrigerated items, e.g., indicators showing when host products have warmed above a refrigerator temperature, the indicators generally need to be refrigerated prior to being paired with a host product, which results in an additional cost and more complicated inventory management and manufacturing process for the user. Using an indicator that requires an application of an activation action before becoming sensitive to environmental exposure may help avoid these problems. Various types of activable indicators have been previously proposed.

The indicators of the present disclosure are generally activatable environmental exposure indicators housing two or more types of activatable indicator which are simultaneously activatable by a single activation action or step (although separate activation actions are contemplated). The activatable environmental exposure indicators may be configured to indicate two or more types of environmental exposure, such as a peak temperature excursion exposure, as well as an exposure to temperatures above a predetermined threshold for at least a predetermined amount of time. Such indicators may be useful in applications involving host products having more than one environmental sensitivity.

The activatable environmental exposure indicators of the present disclosure may employ microcapsules containing a payload. The microcapsules are rupturable by application of an activation action, such as an external application of a compressive or shear force, and/or the application of heat sufficient to melt, weaken, or rupture the frangible shells of the microcapsules to facilitate release of the payload.

In some embodiments of the present disclosure, the payload contained within the microcapsules is environmentally sensitive, or contains environmentally sensitive materials, which exhibit a phase change responsive to a predetermined environmental exposure. The indicators may be configured, along with, in some embodiments, other materials contained in the payload, to produce or display an observable effect in the indicator region responsive to the phase change resulting from the predetermined environmental exposure. The microcapsules are generally configured to prevent this production or display of the observable effect, regardless of exposures to the predetermined environmental exposure, until the microcapsules are ruptured, and the payload is released. In this manner, the indicators are activatable, as the rupturing of the microcapsules may be controlled by a user, such that the indicator does not become environmentally sensitive until the activation action which ruptures the microcapsules is applied.

The discussion contained in the following detailed description has been organized as follows:
Section I: Some Relevant Materials and Notable Properties Thereof.
Section II: Rupturable Microcapsules
Section III: Embodiments of Activatable Environmental Exposure Indicators.

### Section I: Some Relevant Materials and Notable Properties Thereof

### Liquefiable Materials

Various embodiments of activatable environmental exposure indicators discussed herein utilize a liquefiable material that can be configured to react to an environmental exposure temperature above a predetermined threshold relatively quickly. This is because the liquefiable material of some embodiments is configured or selected to have a sharp melting point, such that liquefaction happens very quickly over a small temperature range. Thus, exposure to a predetermined environmental exposure, e.g., a peak temperature exceeding the melting point of the liquefiable material, causes a quick state change. However, notwithstanding a relatively quick response by the liquefiable material to heat, some indicators discussed herein exhibit a time-dependent response that halts when conditions return below the environmental exposure temperature threshold and resumes again in an additive manner. Again, in some embodiments, this is due to the liquefiable material having a sharp transition between a liquid phase and a solid phase.

For example, where an indicator is configured to signal a response after an exposure of about 30 minutes at and/or above the environmental exposure temperature threshold, a 20-minute exposure will not trigger an observable response in the indicator region, but if the indicator is again exposed to a temperature at and/or above the environmental exposure temperature threshold, a reduced amount of exposure, e.g. about 10 more minutes of exposure may yield a response. In some embodiments as noted above, this behavior is achieved because the liquefiable solid (such as a side-chain crystalline polymer) readily liquefies and solidifies within a narrow temperature range. Once the environmental exposure temperature has been exceeded, a drop in temperature below the environmental exposure will cause almost immediate cessation of the time-dependent response with such materials. The response will resume once the environmental exposure temperature threshold is again exceeded.

As used herein, the terms “predetermined environmental exposure” and “environmental exposure temperature threshold” have an understood meaning in the art and include a temperature, usually a temperature above 0° C. (though temperatures below 0° C. are also contemplated), that can cause damage or harm to a product, such as a food or a vaccine that may require refrigeration to avoid spoilage or maintain efficacy for extended periods. The term “environmental exposure temperature threshold,” then, can include any predetermined temperature that is above a desired storage temperature of a perishable product, though in some cases exposure for short periods of time may not damage or harm a particular product. Thus, some embodiments disclosed herein can be configured to provide signal of exposure to temperatures at and/or above an environmental exposure temperature threshold only after a specified amount of time even if exposure occurs at different times.

In some embodiments, the liquefiable material has a “sharp” liquefaction point, meaning that the transition from solid to liquid happens very quickly over a very small temperature range. In some embodiments, liquefaction temperature and solidification temperature of the liquefiable solid are identical. In some embodiments, the liquefaction and solidification temperatures are within about 0.1° C., within about 0.5° C., within about 1.0° C., within about 1.5° C., within about 2° C., within about 2.5° C., within about 3.0° C., within about 3.5° C., within about 4.0° C., within about 4.5° C., within about 5° C., or within about 10° C. of each other.

As used herein, the term “solid phase” may refer to a material in a non-liquid state such that the material is incapable of fluid flow. In some examples “solid phase” may refer to a gelled state, a highly viscous state, a true solid state, and the like. Similarly, the terms “solidification” and “solidify” are used to describe the transition in which a material not in the solid phase enters the solid phase. The terms “solidification point” and “solidification temperature” are used to describe a temperature, or temperature range, at or in which a material may undergo solidification.

As used herein, the term “liquid phase” is used to describe a state of a material in which the material is capable of fluid flow. Similarly, the terms “liquefaction” and “liquefy” are used to describe the transition in which a material not in the liquid phase enters the liquid phase. The terms “liquefaction point” and “liquefaction temperature” are used to describe a temperature, or temperature range, at or in which a material may undergo liquefaction.

Suitable liquefiable materials include synthetic polymeric materials that are solid below the threshold temperature and are, or can become, a flowing amorphous solid or a viscous liquid when at and/or above a threshold temperature. Such synthetic polymeric materials are liquefiable, as defined herein. Useful synthetic polymers can also be hydrophobic, if desired. Suitable liquefiable materials include side-chain crystallizable polymers (e.g., various methacrylates, such as poly(hexadecylmethacrylate); a polymer or a copolymer having at least one crystallizable side chain selected from the group consisting of a C4-30 aliphatic group; a C6-30 aromatic group; a linear aliphatic group having at least 10 carbon atoms; a combination of at least one aliphatic group and at least one aromatic group, the combination having from 7 carbon atoms to about 30 carbon atoms; a C10-C22 acrylate; a C10-C22 methacrylate; an acrylamide; a methacrylamide; a vinyl ether; a vinyl ester; a fluorinated aliphatic group having at least 6 carbon atoms; and a p-alkyl styrene group wherein the alkyl group has from about 8 carbon atoms to about 24 carbon atoms.).

As used herein, the term “polymer”, and its linguistic variations, refers to copolymers, and higher order polymers, as well as homopolymers, unless the context indicates otherwise, for example, by describing or referencing one or more specific homopolymers.

When solid, the synthetic polymeric material can be crystalline or partially crystalline. Crystalline or partially crystalline synthetic polymeric materials can have desirably sharp transitions from a solid state to a liquid state.

Side chain (liquid) crystalline polymers (abbreviated as SCC hereafter) are particularly suitable liquefiable materials, though other suitable materials such as waxes could readily be used. SCC polymers have a conventional polymer backbone and side chains that can co crystallize. Typically, they are chains that have six or more carbons with a crystallization temperature that is, therefore, adjustable. In some embodiments, the side chains “melt” independently of the main polymer chain so that the phenomenon can be used to release other materials that have been encapsulated within the overall polymer structure. Another advantage of SCC polymers is that their molecular weight and degree of crosslinking can be adjusted to control their physical properties including their permeability and in turn provide an approach to tailor the time delay.

Some examples of SCC polymers include poly(dodecylacrylate), poly(tetradecylacrylate), poly(hexadecylacrylate), poly(octadecylacrylate), copolymer of hexylacrylate and dodecylacrylate, copolymer of hexylacrylate and docosylacrylate, copolymer of decylacrylate and tetradecylacrylate, copolymer of decylacrylate and octadecylacrylate, copolymer of decylacrylate and octadecylacrylate, copolymer of decylacrylate and octadecylacrylate, copolymer of dodecylacrylate and docosylacrylate, copolymer of dodecylacrylate and docosylacrylate, copolymer of dodecylacrylate and docosylacrylate, copolymer oftetradecylacrylate and octadecylacrylate, copolymer oftetradecylacrylate and octadecylacrylate, copolymer oftetradecylacrylate and octadecylacrylate, poly(dodecylmethacrylate), poly(tetradecylmethacrylate), poly(hexadecylmethacrylate), poly(octadecylmethacrylate), methacrylate, copolymer of copolymer of tetradecylmethacrylate and methyl octadecylmethacrylate and methyl methacrylate.

For example, the liquefiable material may be a side-chain crystallizable polymer combined with an alkane wax. Some side-chain crystallizable (SCC) polymers useful in the practice of the present disclosure, alone or in combination, and methods that can be employed for preparing them, are described in O'Leary et al. “Copolymers of poly(n-alkyl acrylates): synthesis, characterization, and monomer reactivity ratios” in Polymer 2004 45 pp 6575-6585 (“O'Leary et al.” herein), and in Greenberg et al. “Side Chain Crystallization of n-Alkyl Polymethacrylates and Polyacrylates” J. Am. Chem. Soc., 1954, 76 (24), pp. 6280-6285 (“Greenberg et al.” herein). The disclosure of each of O'Leary et al. and Greenberg et al. is incorporated by reference herein for all purposes.

Side-chain crystallizable polymers, sometimes called “comb-like” polymers, are well-known and available commercially. These polymers are reviewed in J. Polymer Sci. Macromol. Rev. 8:117-253 (1974), the disclosure of which is hereby incorporated by reference. In general, these polymers contain monomer units X of the formula:

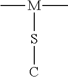

where M is a backbone atom, S is a spacer unit and C is a crystallizable group. These polymers have a heat of fusion (ΔH_{f}) of at least about 20 Joules/g, preferably at least about 40 Joules/g. The polymers will contain about 50 to 100 percent monomer units represented by “X”. If the polymer contains less than 100 percent X, in addition contain monomer units which may be represented by “Y” or “Z”, or both, wherein Y is any polar or nonpolar monomer or mixture of polar or nonpolar monomers capable of polymerizing with X and/or Z, and wherein Z is a polar monomer or mixture of polar monomers. Polar groups, e.g., polyoxyalkylenes, acrylates including hydroxyethylacrylate, acrylamides including methacrylamide-will typically increase adhesion to most substrates. If the polar species “Z” is acrylic acid, it is preferred that it comprise about 1-10 wt. percent of the polymer.

The backbone of the polymer (defined by “M”) may be any organic structure (aliphatic or aromatic hydrocarbon, ester, ether, amide, etc.) or an inorganic structure (sulfide, phosphazine, silicone, etc.), and may include spacer linkages which can be any suitable organic or inorganic unit, for example ester, amide, hydrocar bon, phenyl, ether, or ionic salt (e.g., a carboxyl-alkyl ammonium or sulphonium or phosphonium ion pair or other known ionic salt pair).

The side-chain (defined by ‘S’ and ‘C’) may be aliphatic or aromatic or a combination of aliphatic and aromatic, but must be capable of entering into a crystal line state. Common examples are: linear aliphatic side chains of at least 10 carbon atoms, e.g., C₄-C₂₂ acrylates or methacrylates, acrylamides or methacrylamides, vinyl ethers or esters, siloxanes or alpha olefins; fluorinated aliphatic side-chains of at least 6 carbons; and p-alkyl styrene side-chains wherein the alkyl is of 8 to 24 carbon atoms.

The length of the side-chain moiety is usually greater than 5 times the distance between side-chains in the case of acrylates, methacrylates, vinyl esters, acrylamides, methacrylamides, vinyl ethers and alpha olefins. In the extreme case of a fluoroacrylate alternate copolymer with butadiene, the side-chain can be as little as two times the length as the distance between the branches.

In any case, the side-chain units should make up greater than 50 percent of the volume of the polymer, preferably greater than 65 percent of the volume. Specific examples of side-chain crystallizable monomers are the acrylate, fluoroacrylate, methacrylate and vinyl ester polymers described in J. Poly. Sci 10:3347 (1972); J. Poly. Sci 10:1657 (1972); J. Poly. Sci 9:3367 (1971); J. Poly. Sci 9:3349 (1971); J. Poly. Sci. 9:1835 (1971); J.A.C.S. 76:6280 (1954); J. Poly, Sci 7:3053 (1969); Polymer J. 17:991 (1985), corresponding acryl amides, substituted acrylamide and maleimide polymers (J. Poly. Sci: Poly. Physics Ed. 18:2197 (1980)); polyalphaolefin polymers such as those described in J. Poly. 5,156,911 7 Sci. Macromol. Rey, 8:117-253 (1974) and Macromolecules 13:12 (1980), polyalkylvinylethers, polyalkylethylene oxides such as those described in Macromolecules 13:15 (1980), alkylphosphazene polymers, polyamino acids such as those described in Poly. Sci. USSR 21:241, Macromolecules 18:2141, polyisocyanates such as those described in Macromolecules 12:94 (1979), polyurethanes made by reacting amine- or alcohol-containing monomers with long-chain alkyl isocyanates, polyesters and polyethers, polysiloxanes and polysilanes such as those described in Macromolecules 19:611 (1986), and p-alkylstyrene polymers such as those described in J.A.C.S. 75:3326 (1953) and J. Poly. Sci 60:19 (1962). Of specific utility are polymers which are both relatively polar and capable of crystallization, but wherein the crystallizing portion is not affected by moisture. For example, incorporation of polyoxyethylene, polyoxy propylene, polyoxybutylene or copolyoxyalkylene units in the polymer will make the polymer more polar.

In a particularly preferred embodiment herein, in the above structure, —C is selected from the group consisting of —(CH₂)—CH₃ and —(CF₂)ₙ—CF₂H, where n is an integer in the range of 8 to 20 inclusive, —S— is selected from the group consisting of —O—, —CH₂—, —(CO)—, —O (CO)— and —NR— where R is hydrogen or lower alkyl (1-6° C.), and -M- is —[(CH₂)ₘ—CH]— where m is 0 to 2.

Typical “Y” units include linear or branched alkyl or aryl acrylates or methacrylates, alpha olefins, linear or branched alkyl vinyl ether or vinyl esters, maleicesters or itaconic acid esters, acrylamides, styrenes or substituted styrenes, acrylic acid, methacrylic acid and hydrophilic monomers as detailed in WO84/0387, cited supra.

Some useful side-chain crystallizable polymers, and monomers for preparing side-chain crystallizable polymers, are also available from commercial suppliers, for example, Scientific Polymer Products, Inc., Ontario, N.Y., Sigma-Aldrich, Saint Louis, Mo., TCI America, Portland Oreg., Monomer-Polymer & Dajac Labs, Inc., Trevose, Pa., San Esters Corp., New York, N.Y., Sartomer USA, LLC, Exton Pa., and Polysciences, Inc.

Other suitable liquefiable materials may be alkane waxes alone, without SCCs, or alkane waxes blended with SCCs.

### Frangible Shells

Various embodiments of activatable environmental exposure indicators and activation indicator components discussed herein utilize microcapsules having frangible shells, which are employed to microencapsulate several other materials (e.g., liquefiable materials, indicator materials, thermally expansive materials, thermally expandable microspheres) forming a microcapsule. The frangible shells are rupturable, e.g., the frangible shells rupture and release the payload when subjected to an activation action.

The microcapsules may be any size, but in one such embodiment, has an outer diameter length between 20-1000 μm. The frangible shell may be any size smaller than or equal to the outer diameter of the microcapsule. The microcapsules can have a thickness between 5 to 25 micrometers (μm). The payload ratio, or the ratio of the total weight of the payload within the microcapsule to the entire weight of the microcapsule including the contents contained within the microcapsule, can range from 50 percent to 90 percent. A variety of microcapsule frangible shell materials may be chosen, depending on the application, the mode of rupture, and the nature of the contents of the microcapsule. In general, the microcapsules should resist the passage, whether by flow, diffusion, or migration, of the contents of the microcapsule prior to rupturing.

For example, the frangible shell may be formed in whole or in part by a wax, e.g., an alkane wax, or other acid resistant compound having a relatively high melting point, e.g., fatty acid amide, an ester or Elvax EVA resin. For example, the melting point may be in a range of about 50 degrees Celsius (C) to about 300 degrees C., from about 100 degrees C. to about 300 degrees C., from about 150 degrees C. to about 300 degrees C., from about 200 degrees C. to about 300 degrees C., from about 250 degrees C. to about 300 degrees C. Generally, the shell should have a higher melting point than the maximum temperature the microcapsule is expected to be exposed to in normal use, to prevent it from rupturing or melting prematurely.

In another example, the frangible shell may be formed in whole or in part by a polymer coating having a high glass transition temperature (T_{g}) e.g. Polysulfone. For example, the glass transition temperature may be in a range of about 50 degrees C. to about 300 degrees C., from about 100 degrees C. to about 300 degrees C., from about 150 degrees C. to about 300 degrees C., from about 200 degrees C. to about 300 degrees C., from about 250 degrees C. to about 300 degrees C. For example, Polysulfone, with a T_{g} of about 190 C may be used. In additional examples, the microcapsules 100 may be one of Styrene Maleic Anhydride (SMA), Polyphenylene Ether (PPE), Cellulose Acetate, Cellulose Diacetate, Polyacrylate, Polyamide, Polycarbonate, polyether ether ketone, Polyether Sulfone, PET, PFA, polymethyl methacrylate (PMMA) or Polyimide.

In another example, the frangible shell may be formed in whole or in part by a low molecular weight polymer gel having a high melting point, e.g., fatty acid amide, an ester or Elvax EVA resin. For example, the melting point may be in a range of about 100 degrees C. to about 300 degrees C., from about 150 degrees C. to about 300 degrees C., from about 200 degrees C. to about 300 degrees C., from about 250 degrees C. to about 300 degrees C. Additionally, in some examples, the polymer gel has a molecular weight in a range from about 1 grams per mole (g/mol) to 100,000 g/mol, from about 3,500 g/mol to 6,000 g/mol and from about 200 g/mol to 2,000 g/mol.

Alternatively, the frangible shell may be formed in whole or in part by a gel, gelatin, protein, polyurea formaldehyde, polymelamine formaldehyde, wax material, melamine, or an emulsion. The microcapsules may be available in wet and dry formulations. Polymelamine and polyurea formaldehyde can both be used for encapsulations via interfacial polymerization, which uses two immiscible phases. Once separated in the same vessel, a reaction is initiated at the interface of the two immiscible phases in the presence of an initiator and the material to be encapsulated. As polymerization occurs, microcapsules form around the core material. The microcapsule releases the contents of the microcapsule upon rupturing.

The microcapsule is initially in an unruptured form, capable of being configured to transition to a ruptured form through exposure to an activation action, e.g., the application of heat, pressure, and/or a combination of heat and pressure exceeding a predetermined threshold. In the unruptured form, the frangible shell of the microcapsule maintains separation between the contents of the microcapsule and any external environmental stimuli and/or contains a phase change of the contents of the microcapsule in response to any external environmental stimuli.

The frangible shells may be “ruptured” (e.g., broken, disengaged, dissolved, etc.) by applying an activation action to the microcapsule. In some examples “applying an activation action” may constitute exposing the microcapsule to an activation action, such as a pressure stress or a thermal stress, or a combination thereof. The activation action may directly or indirectly cause the frangible shell to fracture, melt, break, dissolve, sublime, become porous, or otherwise disengage, allowing the release of the contents of the frangible shell. In some examples, the frangible shells may be ruptured by one or more activation actions. In some such examples, simultaneous activation actions may be applied to rupture the microcapsules. In other such examples, ordered or non-ordered sequential activation actions may be applied to rupture the microcapsules.

The frangible shells may have one or more of various rupture modes (e.g., or weaking modes), to which the activation action or actions correspond. Each activation action may be configured to have a predetermined activation threshold at which the microcapsule is configured to rupture. In some examples, each activation action may be configured to have a predetermined activation threshold at which the frangible shell of the microcapsule is weakened (e.g., but not ruptured) to a predetermined extent, such that the predetermined activation threshold of a second activation action necessary to rupture the microcapsule is lowered (when compared to the predetermined activation threshold of the second activation alone). Said differently, a first activation action may lower an energy requirement of a second activation action in order to activate the microcapsule.

A first rupture mode is rupture or weaking by means of externally applied pressure. In some examples, the microcapsules may be ruptured by a source of external pressure, where the activation action is an exposure to a compressive or shearing force. The frangible shells may be configured such that the predetermined activation threshold corresponds to a compression stress or a shear stress of sufficient magnitude to rupture the frangible shell. In some examples, the predetermined stress threshold is a compressive stress or a shearing stress exceeding about 0.1 pounds per square inch (psi), a compressive stress or a shearing stress exceeding about 0.5 psi, a compressive stress or a shearing stress exceeding about 1 psi, a compressive stress or a shearing stress exceeding about 2 psi, a compressive stress or a shearing stress exceeding about 5 psi, a compressive stress or a shearing stress exceeding about 10 psi, or a compressive stress or a shearing stress exceeding about 15 psi. The activation stress ranges given are purely exemplary and the microcapsules can be formed to respond to other stress ranges.

A second rupture mode is rupture or weakening by means of internally applied pressure. In some such examples, the microcapsules may be ruptured or weakened by a source of internal pressure, where the activation action is configured to trigger expansion of a material within the frangible shell (e.g., a volatile material, thermally expandable microsphere) which increases the internal pressure of the microcapsule, which ruptures or weakens the frangible shell.

In some such examples, the predetermined activation threshold corresponds to a radial stress or a hoop stress (e.g., acting on the frangible shell) of sufficient magnitude to rupture the frangible shell. In some examples, the predetermined activation stress threshold is a radial stress or hoop stress exceeding about 0.1 pounds per square inch (psi), a radial stress or hoop stress exceeding about 0.5 psi, a radial stress exceeding about 1 psi, a radial stress exceeding about 2 psi, a radial stress or hoop stress exceeding about 5 psi, a radial stress or hoop stress exceeding about 10 psi, or a radial stress or hoop stress exceeding about 15 psi. The activation stress ranges given are purely exemplary and the microcapsules can be formed to respond to other stress ranges.

A third rupture mode is rupture or weaking by means of heat exposure. In some examples, the microcapsules may be ruptured or weakened by a source of heat, where the activation action is an exposure to a temperature configured to melt, degrade, decrease the structural integrity of, or otherwise disengage the frangible shell. In some such examples, the predetermined activation threshold may correspond to a temperature exceeding about 35 degrees C., a temperature exceeding about 40 degrees C., a temperature exceeding about 45 degrees C., a temperature exceeding about 50 degrees C., a temperature exceeding about 55 degrees C., a temperature exceeding about 60 degrees C., a temperature exceeding about 65 degrees C., a temperature exceeding about 70 degrees C., a temperature exceeding about 75 degrees C., a temperature exceeding about 80 degrees C., a temperature exceeding about 85 degrees C., a temperature exceeding about 90 degrees C., a temperature exceeding about 95 degrees C., and a temperature exceeding about 100 degrees C. The activation heat ranges given are purely exemplary and the microcapsules can be formed to respond to other temperature ranges.

In some such examples, activation may be achieved by applying a high temperature for a very short interval, e.g., a few milliseconds. For example, the mass or heat of fusion of the indicator may be much greater than the mass or heat of fusion of a barrier that needs to be removed, allowing a short exposure to high temperature to remove or alter the microcapsule without significantly affecting a thermally sensitive payload contained in the microcapsule.

In some examples in which two activation actions are required to rupture the microcapsules, the activation actions may employ the same rupture modes, enacted at different thresholds, or different rupture modes.

In some examples, one activation action may trigger multiple rupture modes. As a non-limiting example, a microcapsule may be configured such that the first activation action in an exposure to a temperature above the predetermined activation threshold. The exposure to the temperature above the predetermined activation threshold may trigger a thermally expansive material contained in the microcapsule to expand, providing an internal pressure source, and the exposure may also cause weaking of the frangible shell. In this manner, two rupture modes are enacted on the microcapsule via a single activation action.

In some examples, the activation action(s) may be applied by a thermal printhead (e.g., of a thermal printer). Thermal printheads are generally configured to provide a source of heat (e.g., via heating elements) and a source of external pressure (e.g., via a nib formed between a platen roller and the printhead). Typical thermal print heads have temperatures in the range from about 100° C. to 300° C., which may be tuned downward for select applications to from about 100° C. to 200° C. They are typically exposed to thermal print heads for a brief period of time, for example a few milliseconds. Furthermore, the platen roller may be configured, adjusted, or tuned, such that the external pressure applied by the thermal printhead (e.g., and the platen roller) is in the range of 0.1 psi to 15 psi. As a non-limiting example, the microcapsules may be configured such that the heat from the thermal printhead triggers a thermally expansive material contained in the microcapsule to expand, providing an internal pressure source, which weakens the frangible shell, and the external compressive force of the nib provides sufficient stress to rupture the frangible shell, rupturing the microcapsules.

The activation pressure and temperature ranges given are purely exemplary and other ranges may be sufficient to rupture or weaken the frangible shells, where such pressure ranges may vary based on a composition of the frangible shell, a thickness of the frangible shell, a ratio between the shell thickness or weight to volume or weight of the indicator material, a diameter of the microcapsules, a temperature applied to the shells, etc.

According to some embodiments, the frangible shell is electrically nonconductive, insulative, resistive, or otherwise resists, and may substantially prevent the conduction of electricity through the microcapsule.

### Indicator Materials

According to some embodiments, the microcapsules disclosed herein contain a payload including both a liquefiable material and an accompanying indicator material. When in the solid state, the liquefiable material may substantially prevent movement, migration or diffusion of the indicator material through the liquefiable material. When the liquefiable material is in the liquid state, the indicator material may be able to migrate, move or diffuse through the liquefiable material, and in some examples the indicator material is transportable by the liquefiable material.

Generally, an indicator material produces or facilitates the production of a detectable indication, e.g., a change in color state or electrical property, in response to a predetermined environmental stimulus, e.g., heating above a threshold temperature. When combined with a liquefiable material, the indicator material is configured to produce, either alone or in combination with other elements, a detectable indication when the liquefiable material liquefies (e.g., in response to a predetermined environmental exposure).

The simplest form of indicator material may be a colorant, dye, or other material that may be transported by the liquefiable material.

Some embodiments of indicator materials discussed here utilize two or more compounds capable of reacting with each other to yield a color change. In some examples, the two or more reactants may be separated within a single microcapsule and prevented from mutual contact by a liquefiable material in a solid state. In some embodiments two or more reactants may be and contained in distinct microcapsules, which substantially prevent the compounds from interacting prior to the rupturing of the microcapsules. Alternatively, a first of the compounds may be contained in the microcapsules, and a second of the compounds may be disposed in an indicator region of the indicator.

Used in combination with the liquefiable material, in some embodiments, are color-reacting materials, such as two reactants kept separate by the microcapsules but allowed to react with each other after rupture or migration. Dyes can also be dissolved in such liquefiable materials to provide an intense color. In some embodiments, the color-reacting materials, or color-forming reactants, produce a distinct color change or change in opacity when brought into contact with each other. A common example is the use of a leuco dye system.

When the reactants come into contact, the appearance change of the indicator may be to go from clear to black, from clear to a dark color, from a light color to a dark color, from a light color to black, etc. In some embodiments, a background is visible through the liquefiable layer(s) prior to the reaction, thereby indicating that the predetermined temperature threshold and required exposure period have not yet been satisfied. The background may include words, numbers, or a pattern, or may simply comprise a color that is easily obscured by the color-forming reaction of the reactants. In some embodiments, a pattern on the background is at least partially obscured by the light color of the liquefiable layer(s), and the pattern becomes more visible after the color-forming reaction. For example, if the pattern is formed with an ink having a color similar to the color of the pre-reacted reactants, a color change produced by the interaction of the color-forming reactants may render the pattern more visible.

In some examples, the liquefiable material may also serve as an indicator material. Some liquefiable materials exhibit visibly detectable changes when undergoing a phase change, such as changes in opacity. Some indicators of the present disclosure may rely on such visibly detectable changes of the liquefiable material as the production of the observable effect, and include components configured to visually emphasize the visibly detectable change when the change occurs.

Some embodiments discussed herein utilize conductive particles which, when employed in tandem with a liquefiable material, may be held separately from one another when the liquefiable material is in the solid phase, and be configured to form an electrical connection between two electrodes when the liquefiable material is in the liquid phase. Thus, by measuring the conductivity between the two electrodes, the state of the liquefiable material can be determined, or rather, an exposure of the liquefiable material to the predetermined environmental exposure may be confirmed. According to some embodiments, the conductive particles may include particles of conductive metals, such as copper, silver, gold, aluminum, zinc, tin, similar metals, and alloys thereof. The conductive particles may also include particles of graphene, graphite, carbon black, graphene oxides, and other functionalized graphenes, and particles containing conductive non-metals. The conductive particles may be formed in whole or in part by any electrically conductive substance or material operable to be particlized to a sufficient size to fit within the shell of a microcapsule.

Some embodiments of indicator materials discussed herein utilize colored or bright materials, such as dyes, flash materials, and other colorants. In some examples, liquefaction of the liquefiable material may result in a change in opacity of the liquefiable material, which may reveal or obscure the indicator material. In some examples, the liquefiable material may transport the indicator material from a non-viewable or concealed location to a viewable location when in the liquid state.

### Section II: Rupturable Microcapsules

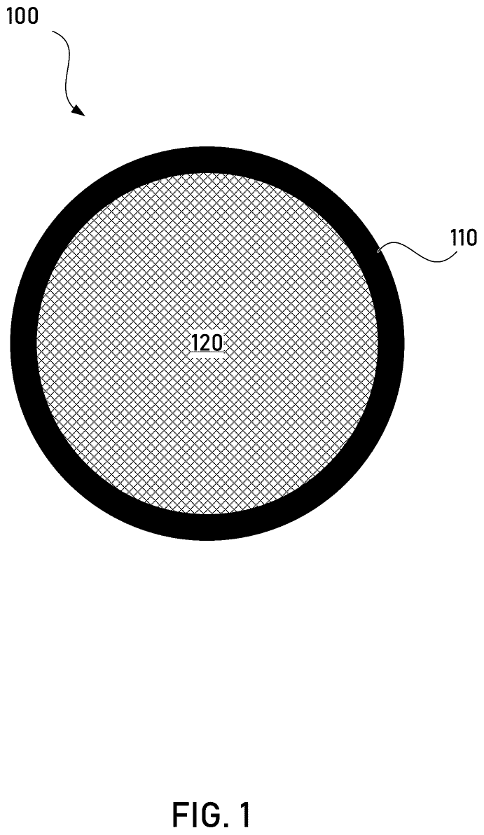

FIG. 1 illustrates a cross-sectional view of a microcapsule 100, as may be used in an activatable indicator, according to embodiments of the present disclosure.

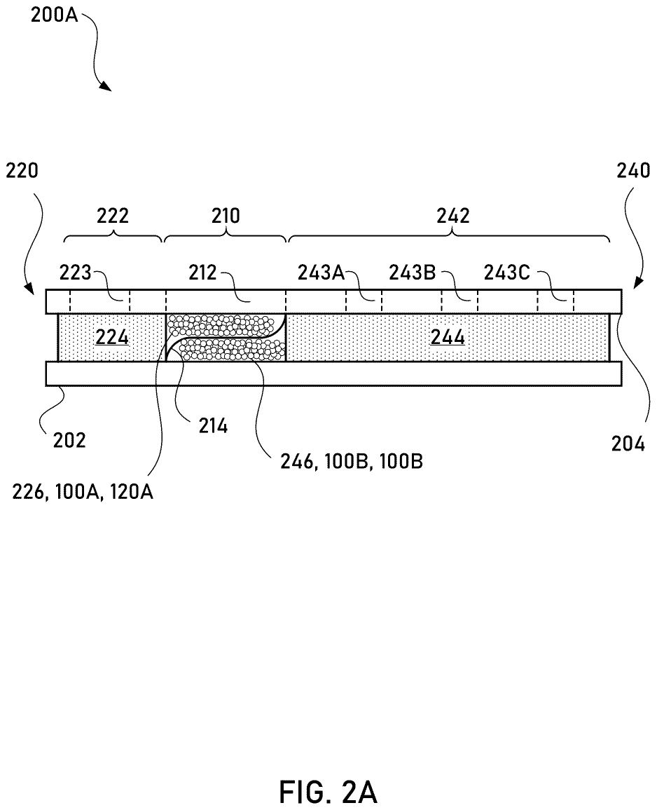

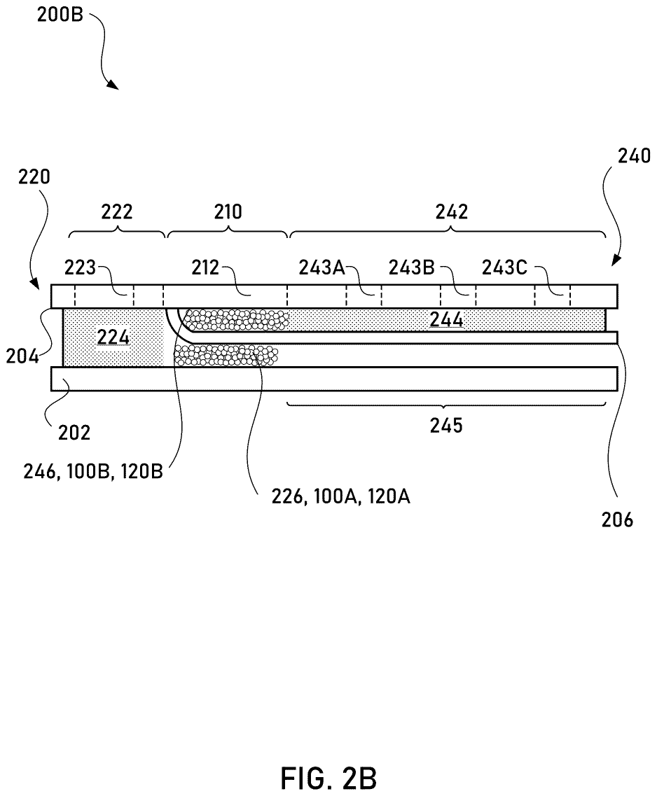

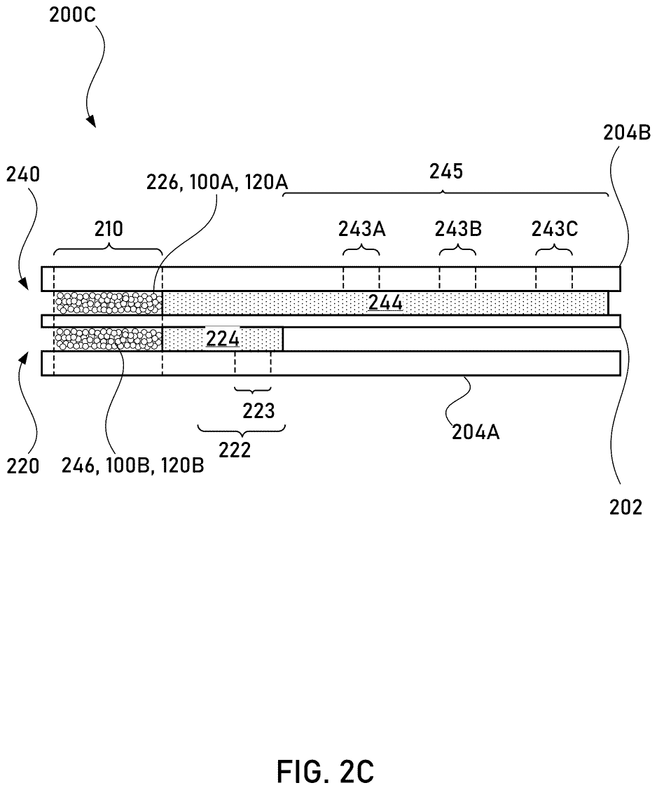

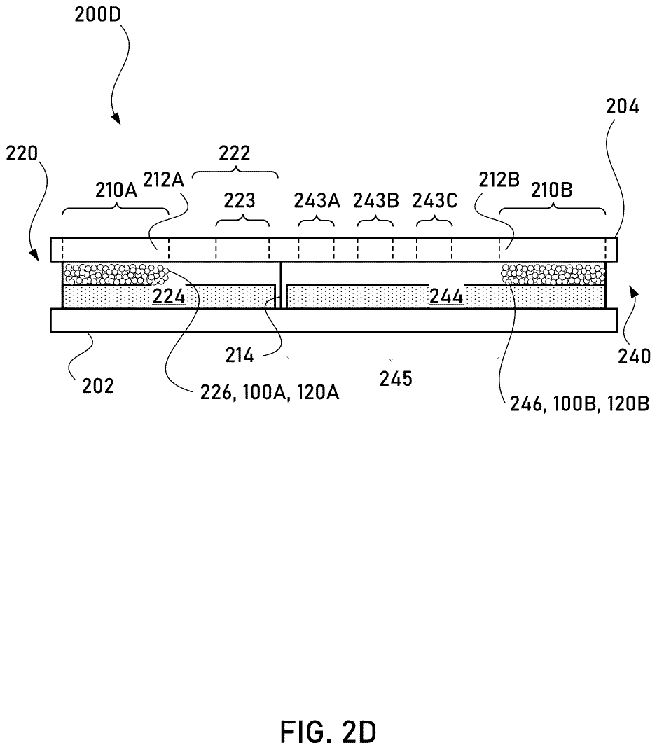

The microcapsule 100 includes a frangible shell 110. The frangible shell 110 contains a payload 120. In some examples, the payload 120 includes a liquefiable material combined with an indicator material, which may be configured to produce an effect (e.g., either alone or in tandem with elements of an indicator (see FIGS. 2A-2D) when the liquefiable material transitions from a solid phase to a liquid phase.

With respect to the payload 120, in some examples, the liquefiable material forms a solid matrix when in the solid phase, such that indicator material is embedded within a matrix formed by the liquefiable material. When the liquefiable material liquefies, the liquefiable material may act as a transport material with respect to the indicator material. When liquefiable material liquefies, the indicator material is released from the matrix and movement of the indicator material is facilitated through the liquefied liquefiable material. Furthermore, the when the liquefied liquefiable material is acted upon (e.g., by wicking action, capillary action, gravity or other forces) and compelled to motion, the liquefied liquefiable material may transport the indicator material as the liquefiable material moves.

In the present disclosure, the payload 120 includes a sufficient proportion of the liquefiable material that when the liquefiable material liquefies, the payload 120 as a whole, notwithstanding suspended or contained solids (e.g. indicator materials) being contained therein, substantially acts as a liquid. Thus, throughout the disclosure the payload 120 may be said to liquefy. It is understood that reference to the payload 120 liquefying or being liquefied (e.g., and other variations across parts of speech) indicates only that the liquefiable material within the payload 120 is liquefied. Such language does not imply or indicate that the payload 120 does not contain or include non-liquid materials, nor does such language indicate that any material within the payload 120 apart from the liquefiable material is necessarily liquefied.

According to some embodiments, the liquefiable material of the payload 120 may be one of, or a combination of the liquefiable materials listed above in Section I. Furthermore, the indicator material may be one of, or a combination of, the indicator materials listed above in Section I. Moreover, payload 120 materials (e.g., liquefiable materials and indicator materials) may be selected according to other features or design constraints of the indicators with which the microcapsules 100 are to be employed. Some liquefiable materials may exhibit advantageous properties with some wicks, some indicator materials, some temperature ranges, and so forth.

The microcapsule 100 may be any size, but in one such embodiment, has an outer diameter length between 20 to 1000 micrometers (μm). The frangible shell 110 may be any size smaller than or equal to the outer diameter of the microcapsule 100. The frangible shell 110 can have a thickness of between 5 to 25 μm. The ratio of the total weight of the contents (e.g. thermally expandable microsphere 130, payload 120) within the microcapsule 100 to the entire weight of the microcapsule 100 including the contents contained within the microcapsule 100, can range from 50 percent to 90 percent. A variety of frangible shell 110 materials may be chosen, depending on the application, and the nature of the payload 120 of the microcapsule 100. In general, the frangible shells 110 should resist the passage, whether by flow, diffusion, or migration, of the payload 120 of the microcapsule 100, prior to activation.

Generally speaking, the microcapsule 100 is configured to be activated responsive to an application of an activation action, or in some examples, two activation actions. When activated, the frangible shell 110 of the microcapsule 100 is disengaged, such that the payload 120 of the microcapsule 100 is exposed to the environment. When the payload 120 is exposed to the environment, an exposure to the predetermined environmental exposure causes the payload 120 to transition to the liquid state. In this manner, when the payload 120 is exposed to the environment, the payload 120 is primed to begin sensing, or is environmentally sensitive.

The microcapsule 100 may be “activated” or ruptured by exposing the microcapsule 100 to an activation action (e.g. activation stress, activation exposure, activation event, etc.) exceeding a predetermined activation threshold. The activation action may cause the microcapsule 100 to fracture, melt, break, dissolve, sublime, become porous, or otherwise disengage, allowing the release of the contents of the microcapsule 100.

In some cases, pressure contributes to the activation, e.g., by breaking microcapsules 100, either alone or in combination with elevated temperature. In such embodiments, the activation action is a compressive stress, or a shearing stress, where the predetermined activation threshold is a stress exceeding about 0.1 pounds per square inch (psi), a stress exceeding about 0.5 psi, a stress exceeding about 1 psi, a stress exceeding about 2 psi, a stress exceeding about 5 psi, a stress exceeding about 10 psi, or a stress exceeding about 15 psi.

Generally, prior to activation, the frangible shells 110 are configured to block the payload 120 from flowing, diffusing, or otherwise being released from the microcapsule 100, whether the payload 120 is liquefied or solidified.

### Section III: Embodiments of Activatable Environmental Exposure Indicators

### Dual Activatable Environmental Exposure Indicator: First Embodiment

FIG. 2A illustrates a first embodiment of an activatable environmental exposure indicator 200A (e.g., thermal exposure indicator), according to embodiments of the present disclosure. The activatable environmental exposure indicator 200A contains a first type of environment indicator, e.g., an excursion exposure indicator 220 (e.g., high temperature excursion indicator) and a second type of environment indicator, e.g., a time-dependent exposure indicator 240 (e.g., time-temperature indicator). The activatable environmental exposure indicator 200 includes an activation region 210 configured to activate both the excursion exposure indicator 220 and the time-dependent exposure indicator 240, a first indicator region 222 in which the excursion exposure indicator 220 is configured to produce a first observable effect, and a second indicator region 242 in which the time-dependent exposure indicator 240 is configured to produce a second observable effect.

Generally speaking, the excursion exposure indicator 220 is configured to indicate (e.g., via the production of the first observable effect in the first indicator region 222) that the activatable environmental exposure indicator 200A has been exposed to a first predetermined environmental exposure, where the first predetermined environmental exposure is at least a single excursion above (e.g., or below, in some examples) an exposure threshold of an environmental condition. The time-dependent exposure indicator 240 is configured to indicate (e.g., via the production of the second observable effect in the second indicator region 242) that the activatable environmental exposure indicator 200A has been exposed to a second predetermined environmental exposure, where the second predetermined environmental exposure is an exposure above an exposure threshold of an environmental condition for at least a predetermined amount of time, in which the exposure may be continuous or discontinuous.

In some examples, the first predetermined environmental exposure may be a temperature excursion above a predetermined temperature threshold, temperature excursion below a predetermined temperature threshold, an exposure to a particular chemical, an oxygen exposure, an ammonia exposure, an exposure to a particular chemical above a threshold concentration, an exposure to a particular chemical above the threshold concentration, an exposure to at least a predetermined amount of radiation of a particular type, a predetermined electromagnetic exposure, a humidity exposure, and an exposure to a humidity level above a predetermined threshold.

In some examples, the second predetermined environmental exposure may be a temperature excursion above a predetermined temperature threshold for at least a predetermined amount of time, temperature excursion below a predetermined temperature for at least a predetermined amount of time, cumulative exposure to temperature over a time period above a predetermined threshold for at least a predetermined amount of time, an exposure to a particular chemical for a predetermined period of time, an oxygen exposure lasting for a predetermined period of time, an ammonia exposure lasting for a predetermined period of time, an exposure to a particular chemical above a threshold concentration for at least a predetermined period of time, an exposure to a particular chemical above the threshold concentration for at least a predetermined amount of time, an exposure to at least a predetermined amount of radiation of a particular type for at least a predetermined amount of time, a predetermined electromagnetic exposure for at least a predetermined amount of time, and an exposure to a humidity level above a predetermined threshold for at least a predetermined amount of time.

The excursion exposure indicator 220 includes a first reservoir 226 containing microcapsules 100A, each microcapsule 100A including a first payload 120A microencapsulated in a frangible shell 110, where the first payload 120A is configured to liquefy responsive to a first predetermined environmental exposure. The first reservoir 226 is aligned with the activation region 210, such that when a compressive force is applied to the activation region 210, a compressive stress is transferred to the microcapsules 100A contained in the first reservoir 226 and thus the activation action is applied to the microcapsules 100A, and the frangible shells 110 are ruptured, releasing the first payload 120A.

According to some embodiments, the first indicator region 222 includes a first wick 224 that is in fluid communication with the first reservoir 226 of the activation region 210. In some embodiments, the first wick 224 can extend into the first reservoir 226 such that all or at least some of the microcapsules 100A are disposed on or under the first wick 224. The indicator region 222 may further include a first viewing window 223 disposed in the cover layer 204 such that the observable effect, or the results thereof, is viewable to a user viewing the activatable environmental exposure indicator 200A. In some examples the first viewing window 223 is a removed portion of the cover layer 204, or a transparent portion of the cover layer 204.

In some examples, after the application of the activation action, (e.g., after the frangible shells 110 of the microcapsules 100A are ruptured and the first payload is released therefrom), and responsive to the first predetermined environmental exposure, the payload 120 liquefies and migrates into the first wick 224. As the excursion exposure indicator 220 is configured to indicate a single excursion above a predetermined threshold, the wick 224 and the first payload 120A may be configured such that the liquefied first payload 120A rapidly migrates into the first wick 224 and produces the first observable effect immediately (e.g., having a predetermined indication time, the predetermined indication time being 1 minute or less, 30 seconds or less, or 10 seconds or less).

In various embodiments the first indicator region 222 may include other components or take other forms. In some examples the first indicator region 222 may include a destination reservoir (not shown) or other destination component for the first payload 120A.

The first payload 120A is configured to produce an observable effect upon reaching the first indicator region 222. In some examples, the indicator material of the first payload 120A is a dye, ink, or other colorant, and the wick 224 appears to change from an initial color state to a second color state as the wick 224 is saturated by the first payload 120A. In some examples, indicator material is a two-component dye or ink, which produces a change in color state upon mixing two reactants together. In some examples, a first reactant (e.g., a color former) and a second reactant (e.g., a color developer) are separately held in separate microcapsules of the microcapsules 100A, where, upon release from the microcapsules, and the liquefaction of the liquefiable material, the first and second reactants are mixed, producing the color change which is transferred to the first indicator region 222 as the liquefied first payload 120A migrates thereto. In other examples, the first reactant is contained in the microcapsules 100A and the second reactant is contained in the first indicator region 222, such that when the liquefied first payload 120A reaches the first indicator region 222 the first and second reactants are mixed, producing the color change in the first indicator region 222.

In some examples, the indicator material in the first payload 120A may be a flash material, which is configured to give off a bright appearance when illuminated with light of a predetermined wavelength. In some examples, the indicator material in the payload 120A may be a conductive material, such that the observable effect is a change in an electrical property of the first indicator region 222.

In some examples, the liquefiable material is configured or selected such that the payload 120A remains liquefied after the predetermined environmental exposure ceases, (e.g., after the environmental condition returns to a state which does not exceed the predetermined excursion threshold). In this manner, the liquefied payload 120A is not prevented from producing the observable effect in the first indicator region 222 due to a state change of the liquefiable material.

The time-dependent exposure indicator 240 includes a second reservoir 246 containing microcapsules 100B, each microcapsule 100B including a second payload 120B microencapsulated in a frangible shell 110, where the second payload 120B is configured to liquefy responsive to a second predetermined environmental exposure. The second reservoir 246 is aligned with the activation region 210, such that when a compressive force is applied to the activation region 210, a compressive stress is transferred to the microcapsules 100B contained in the second reservoir 246 and thus the activation action is applied to the microcapsules 100B, and the frangible shells 110 are ruptured, releasing the second payload 120B.

According to some embodiments, the second indicator region 242 includes a second wick 244 that is in fluid communication with the second reservoir 246 of the activation region 210. In some embodiments, the second wick 244 can extend into the second reservoir 246 such that all or at least some of the microcapsules 100B are disposed on or under the second wick 244. The second indicator region 242 may further include a plurality of second viewing windows 243A-C (generally or collectively second viewing windows 243) disposed in the cover layer 204 such that the second observable effect, or the results thereof, is viewable to a user viewing the activatable environmental exposure indicator 200A. In some examples the second viewing windows 243 are removed portions of the cover layer 204, or transparent portions of the cover layer 204.

In some examples, after the application of the activation action, (e.g., after the frangible shells 110 of the microcapsules 100B are ruptured and the second payload 120B is released therefrom), and responsive to the second predetermined environmental exposure, the second payload 120B liquefies and migrates into the second wick 244. As the excursion exposure indicator 220 is configured to indicate an amount of time for which the activatable environmental exposure indicator 200A is exposed to an environmental condition exceeding a predetermined threshold, the second indicator region 242 is a migration region through which the liquefied second payload 120B is configured to migrate at a predetermined rate. The second observable effect progresses through the second wick 244 such that a distance through the migration region that the liquefied second payload 120B has migrated corresponds to an amount of time for which the activatable environmental exposure indicator 200A has been exposed to the environmental condition exceeding the predetermined threshold. The second payload 120B and the second wick 244 may be configured to indicate any amount of time that the activatable environmental exposure indicator 200A is exposed to the environmental condition exceeding the predetermined threshold, but as a non-limiting example, the time-dependent exposure indicator 240 may be configured to indicate cumulative exposure durations of about 10 minutes, about 30 minutes, about 1 hour, about 3 hours, about 10 hours, or of about 24 hours.

The liquefiable material of the second payload 120B may also be configured to solidify and halt migration of the second payload 120B when the environmental condition no longer exceeds the predetermined threshold. In this manner, the second payload 120B is only liquefied and migrates through the migration region when the environmental condition exceeds the predetermined threshold and is solidified and does not migrate through the migration region when the environmental condition does not exceed the predetermined threshold. As the payload 120B migrates through the wick 244 and the migration region, the payload 120B may cause the production of the second observable effect in the portions of the second wick 244 through which the payload 120B has migrated, and the portions of the second wick 244 which the payload 120B has not migrated through remain in an initial state, where the observable effect has not (e.g., not yet) been produced.

The activatable environmental exposure indicator 200A may include various indices which correspond to different amounts of time that the activatable environmental exposure indicator 200A has been exposed to the environmental condition exceeding the predetermined threshold. In some examples, the plurality of second viewing windows 243 includes a single window through which the migration region is viewable, and the cover layer includes printed indicia corresponding to locations within the migration region such that a the distance along the second wick 244 that the payload has travelled is correlated to a specific interval of time which the activatable environmental exposure indicator 200A has been exposed to the environmental condition exceeding the predetermined threshold. In some examples, the plurality of second viewing windows 243 includes several second viewing windows 243, each second viewing window 243 disposed at a predetermined location relative to the second wick 244 and the migration region, such that when the second observable effect is viewable through a given second viewing window 243, a user may determine that the activatable environmental exposure indicator 200 has been exposed to the environmental condition exceeding the predetermined threshold for at least the predetermined amount of time which corresponds to the given second viewing window 243.

In various embodiments the second indicator region 242 may include other components or take other forms. In some examples the second indicator region 242 and the migration region may include microchannels configured to support migration of the liquefied second payload 120B.

The second payload 120B is configured to produce an observable effect upon reaching the second indicator region 242. In some examples, the indicator material of the second payload 120B is a dye, ink, or other colorant, and the second wick 244 appears to change from an initial color state to a second color state as the second wick 244 is saturated by the second payload 120B. In some examples, the indicator material is a two-component dye or ink, which produces a change in color state upon mixing two reactants together. In some examples, a first reactant (e.g., a color former) and a second reactant (e.g., a color developer) are separately held in separate microcapsules of the microcapsules 100B, where, upon release from the microcapsules, and the liquefaction of the liquefiable material, the first and second reactants are mixed, producing the color change which is transferred to the second indicator region 242 as the liquefied second payload 120B migrates thereto. In other examples, the first reactant is contained in the microcapsules 100B and the second reactant is contained in the second indicator region 242, such that when the liquefied second payload 120B reaches the second indicator region 242 the first and second reactants are mixed, producing the color change in the second indicator region 242.

In some examples, the indicator material in the second payload 120B may be a flash material, which is configured to give off a bright appearance when illuminated with light of a predetermined wavelength. In some examples, the indicator material in the second payload 120B may be a conductive material, such that the observable effect is a change in an electrical property of the second indicator region 242.

The first reservoir 126 and the second reservoir 146 are both disposed in the activation region 210 of the activatable environmental exposure indicator 200A, and the first reservoir 126 is separated from the second reservoir 146 by a membrane 214. The membrane 214 is generally configured to block the microcapsules 100A and the payload 120A thereof from contact with the second wick 244 (e.g., when liquefied and when not liquefied), and block the microcapsules 100B and the payload 120B (e.g., when liquefied and when not liquefied) thereof from contacting the first wick 124. Generally speaking, the microcapsules 100A is physically isolated from the microcapsules 100B by a membrane 214. According to some embodiments, the membrane is coupled to the cover layer 204 and to the substrate 202. The first reservoir and the second reservoir 246 are aligned such that both the excursion exposure indicator 220 and the time-dependent exposure indicator 240 are activatable simultaneously, by a single activation action applied to the activatable environmental exposure indicator 200A. When a compressive force (e.g., as may be provided by thumb pressure) is applied to the activation region 210, the activation action is applied to the microcapsules 100A and the microcapsules 100B simultaneously.

As illustrated, the first reservoir 226 is formed between the membrane 214 and the cover layer 204, and the second reservoir 246 is formed between the membrane 214 and the substrate 202. In various embodiments, the membrane 214 may be configured such that the opposite is true, where the first reservoir 226 is formed between the membrane 214 and the substrate, and the second reservoir 246 is formed between the membrane and the cover layer 204.

In some examples, the first reservoir and the second reservoir 146 include surfaces (e.g., the membrane 214, the cover layer 204, the substrate 202) which may be abrasive in quality, or include an abrasive material, which is configured to aid in the rupturing of the microcapsules 100 when the activation action is applied thereto. When the compressive force is applied to the activation region 210, the abrasive surfaces may increase a proportion of the microcapsules 100 which are successfully ruptured by the activation action, thus increasing efficacy of the activatable environmental exposure indicator 200A and reducing potential for user error.

According to some embodiments, the activation region 210 includes a depressible portion 212. The depressible portion 212 is configured to be deformable, or extendable towards the substrate, so as to prevent substantial deformation of other components of the activatable environmental exposure indicator 200A, such as the first wick 224 and the second wick 244 when the compressible force is applied to the activatable environmental exposure indicator 200A. In some examples, the depressible portion 212 may be uniformly deformable, and be constructed of a material which is distinct from the material from which cover layer is constructed. In some examples the depressible portion 212 may be an area of the cover layer 204 which is defined by a line of weakness, the line of weakness configured to permit the depressible portion 212 to at least partially separate from the cover layer 204 to facilitate the deformation of the activation region. In some examples, the depressible portion 212 may include a deformable border portion, which is configured to permit an included rigid portion to extend below the plane of the cover layer 204 when the compressive force is applied. In some examples, the deformation of the components of the activatable environmental exposure indicator 200A responsive to the compressive force is of a sufficiently small degree that the depressible portion may not be otherwise distinguished from the cover layer, save for indicia demarcating the location of the activation region 210.

In some examples, the first predetermined environmental exposure and the second predetermined environmental exposure which the activatable environmental exposure indicator 200A is configured to indicate are of the same type. Said different, the excursion exposure indicator 220 may be configured to indicate a high-temperature excursion, or rather, an exposure to a temperature above a first predetermined high temperature threshold, and the time-dependent exposure indicator 240 may be configured to indicate a period of time for which the indicator has been exposed to a temperature above a second predetermined high temperature threshold. In this manner, the activatable environmental exposure indicator 200A may serve as a spoilage indicator for thermally sensitive products. For example, a product (e.g., host product) may have two thermal spoilage conditions, the first being where the product reaches a temperature above the first predetermined high temperature threshold, and the second being a period of time of a predetermined duration in which the product is at a temperature above the second predetermined high temperature threshold. When the activatable environmental exposure indicator 200A is associated with the product and activated (e.g., after the application of the activation action) the activatable environmental exposure indicator 200A will produce an observable effect responsive to cither of the above spoilage conditions, should either come to pass, thus indicating potential spoilage of the product.

Although illustrated as substantially open-ended for simplicity, it is noted that the activatable environmental exposure indicator 200A may be sealed about a perimeter of the activatable environmental exposure indicator 200, such that all of the components contained between the cover layer 204 and the substrate 202 are sealed therebetween. In some embodiments, the substrate 202 and cover layer 204 can be separate and distinct components that are sealed together about the perimeter. In some embodiments, the substrate 202 and cover layer 204 can be formed by a single sheet of material that is folded upon itself and subsequently sealed about its perimeter.

### Dual Activatable Environmental Exposure Indicator: Second Embodiment

FIG. 2B illustrates a second embodiment of the activatable environmental exposure indicator 200B, according to embodiments of the present disclosure. Generally speaking, the activatable environmental exposure indicator 200B operates similarly to the activatable environmental exposure indicator 200A but differs in construction. Except where noted in the following, the discussion of the first embodiment of the activatable environmental exposure indicator 200A and the components, properties, and features thereof, apply to the second embodiment of the activatable environmental exposure indicator 200B.

The second embodiment of the activatable environmental exposure indicator 200B includes an intermediate layer 206 in lieu of the membrane 214 of the first embodiment of the activatable environmental exposure indicator 200A. The intermediate layer 216 is disposed between the cover layer 204 and the substrate 202, such that the time-dependent exposure indicator 240 is scaled between the intermediate layer 206 and the cover layer 204. The first reservoir 226 is disposed between the intermediate layer 206 and the substrate 202, and adjacent the first wick 224, and the intermediate layer 206 is coupled to the cover layer 204 between the first wick 224 and the second reservoir 246, separating the first wick 224 from the second reservoir 246.

Alternatively the activatable environmental exposure indicator 200B may be constructed such that the excursion exposure indicator 220 is scaled between the intermediate layer 206 and the cover layer 204, and the second reservoir 246 is disposed between the intermediate layer 206 and the substrate 202, and adjacent to the second wick 244 and the intermediate layer 206 is coupled to the cover layer 204 between the second wick 244 and the first reservoir 226, separating the second wick 244 from the first reservoir 226.

### Dual Activatable Environmental Exposure Indicator: Third Embodiment

FIG. 2C illustrates a third embodiment of the activatable environmental exposure indicator 200C, according to embodiments of the present disclosure. Generally speaking, the third embodiment of the activatable environmental exposure indicator 200C operates similarly to the activatable environmental exposure indicator 200A but differs in construction. Except where noted in the following, the discussion of the first embodiment of the activatable environmental exposure indicator 200A and the components, properties, and features thereof, apply to the third embodiment of the activatable environmental exposure indicator 200C.

In the third embodiment of the activatable environmental exposure indicator 200C, the time-dependent exposure indicator 240 is disposed on a first surface of the substrate 202, and the excursion exposure indicator 220 is disposed on an opposed surface of the substrate 202. In this manner, the substrate 202 serves as an intermediate layer. The activatable environmental exposure indicator 200C includes a first cover layer 204A and a second cover layer 204B. The first cover layer 204A overlays the excursion exposure indicator 220, and includes the viewing window 223. The second cover layer 204B overlays the time-dependent exposure indicator 240 and includes the viewing windows 243A-C. One or both of the first cover layer 204A and the second cover layer 204B may include indicia indicating the activation region 210.

The activatable environmental exposure indicator 200C therefore has two viewable faces which are mutually opposed, however the first reservoir 226 and the second reservoir 246 arc aligned, such that the time-dependent exposure indicator 240 and the excursion exposure indicator 220 are activatable responsive to a single activation action.

### Separately Activatable Dual Environmental Exposure Indicator

FIG. 2D illustrates a fourth embodiment of the activatable environmental exposure indicator 200D, according to embodiments of the present disclosure. Generally speaking, the fourth embodiment of the activatable environmental exposure indicator 200D operates similarly to the activatable environmental exposure indicator 200A but differs in construction. Except where noted in the following, the discussion of the first embodiment of the activatable environmental exposure indicator 200A and the components, properties, and features thereof, apply to the fourth embodiment of the activatable environmental exposure indicator 200D.

In the fourth embodiment of the activatable environmental exposure indicator 200D, the excursion exposure indicator 220 and the time-dependent exposure indicator 240 are both disposed on a shared and level surface of the substrate 202 in a non-overlapping manner, where the excursion exposure indicator 220 and the time-dependent exposure indicator 240 can be separated by a barrier, e.g., such as an embodiment of the membrane 214. The first reservoir 226 and the second reservoir 246 are spaced away from one another, and the activatable environmental exposure indicator 200D accordingly includes a first activation region 210A and a second activation region 210B, each of which may respectively include a depressible portion (e.g., first depressible portion 212A, second depressible portion 212B). The activatable environmental exposure indicator 200D may be configured to receive two activation actions, or a single activation applied twice in order to activate both the excursion exposure indicator 220 and the time-dependent exposure indicator 240.

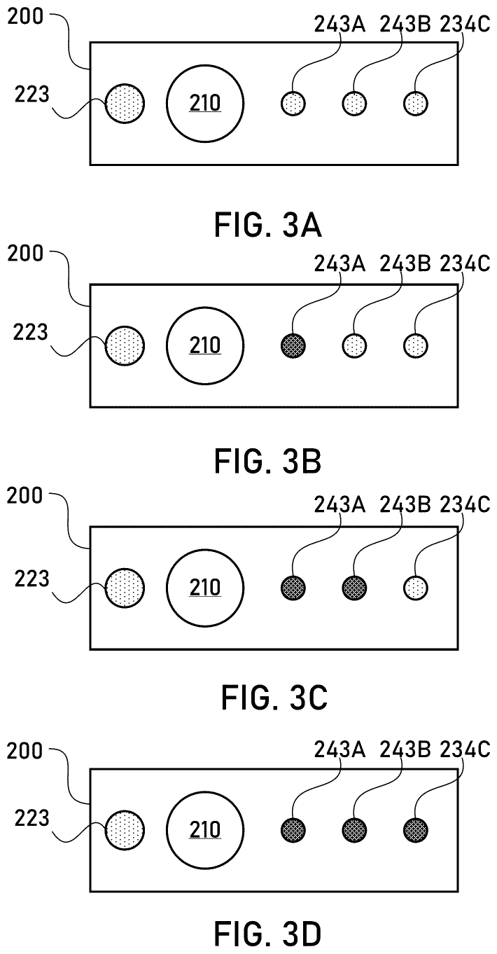

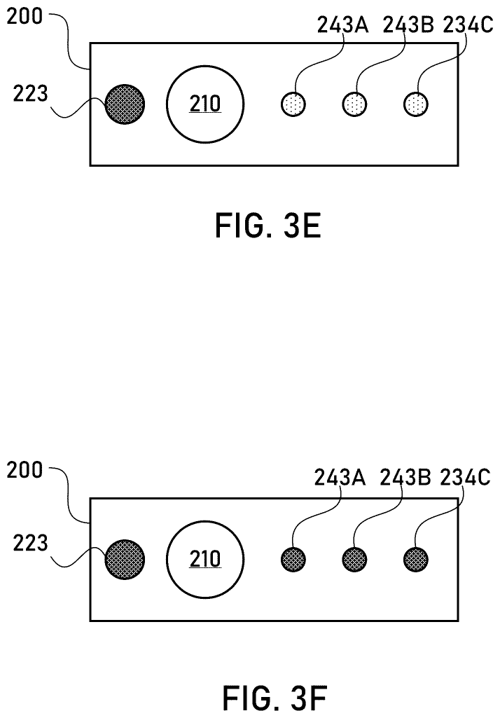

FIGS. 3A-3E illustrate profile views of an example activatable environmental exposure indicator 200 in various stages of exposure. The example activatable environmental exposure indicator 200 is intended to represent all of the previous examples of the activatable environmental exposure indicator and is included to provide clarity on the manner of indication, not inform or limit the structural features of an activatable environmental exposure indicator. The example activatable environmental exposure indicator 200 includes an excursion exposure indicator 220 configured to produce the first observable effect in the indicator region 222, which is viewable through the first viewing window 223 and includes a time-dependent exposure indicator 240 configured to produce the second observable effect in the migration region 245, portions of which are viewable through the plurality of second windows 243A-C. Each second viewing window 243 is aligned with a portion of the migration region 245 which corresponds to a predetermined amount of time for which the activatable environmental exposure indicator 200 has been exposed to the environmental condition exceeding the predetermined threshold for at least the predetermined amount of time which corresponds to the given second viewing window 243.

FIG. 3A illustrates the activatable environmental exposure indicator 200 prior to either an excursion exposure or a time-dependent exposure, as the first observable effect has not occurred in the indicator region 222, and the second observable effect has not occurred in the migration region 245. According to some embodiments, the activatable environmental exposure indicator 200 may be activated or unactivated as illustrated in FIG. 3A.

FIG. 3B illustrates the activatable environmental exposure indicator 200 after activation and after being exposed to the second predetermined environmental exposure for at least a first predetermined amount of time, as the time-dependent exposure indicator 240 has produced the second observable effect in a first of the second viewing windows 243A.

FIG. 3C illustrates the activatable environmental exposure indicator 200 after activation and after being exposed to the second predetermined environmental exposure for at least a second predetermined amount of time, greater than the first predetermine period of time, as the time-dependent exposure indicator 240 has produced the second observable effect in the first and a second of the second viewing windows 243A-B.

FIG. 3D illustrates the activatable environmental exposure indicator 200 after activation and after being exposed to the second predetermined environmental exposure for at least a third predetermined amount of time, greater than the second predetermined period of time, as the time-dependent exposure indicator 240 has produced the second observable effect in the first, the second and a third of the second viewing windows 243A-C.

FIG. 3E illustrates the activatable environmental exposure indicator 200 after activation and after being exposed to the first predetermined environmental exposure, as the excursion exposure indicator 220 has produced the first observable effect in the first viewing window 223. The activatable environmental exposure indicator 200 may have been exposed to the second predetermined environmental exposure, however the exposure has not lasted for at least the first predetermined amount of time, as the second observable effect has not been produced in any of the second viewing windows 243.

FIG. 3F illustrates the activatable environmental exposure indicator 200 after activation and after being exposed to the first predetermined environmental exposure, and the second predetermined environmental exposure for at least a third predetermined amount of time, as the first observable effect has been produced in the indicator region 222, as is viewable through the first viewing window 223 and the time-dependent exposure indicator 240 has produced the second observable effect in the first, the second and a third of the second viewing windows 243A-C.

In the foregoing specification, specific embodiments have been described. However, one of ordinary skill in the art appreciates that various modifications and changes can be made without departing from the scope of the technology as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed technology is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An activatable environmental exposure indicator, comprising:
a substrate;
a cover layer overlaying the substrate;
a first reservoir and a second reservoir, separately disposed between the substrate and the cover layer and within in an activation region;
a first plurality of microcapsules disposed in the first reservoir, each microcapsule of the first plurality of microcapsules including a first payload microencapsulated in a first frangible shell;
wherein the first payload includes a first liquefiable material configured to liquefy responsive to a first predetermined environmental exposure,
wherein the first frangible shells are configured to rupture responsive to an application of an activation action, releasing the first payload from the first frangible shells, and
wherein the first payload is configured to produce a first observable effect in a first indicator region responsive to the first liquefiable material being liquefied after the first payload is released from the frangible shells,
wherein the first frangible shells are configured to block the first payload from producing the first observable effect in the first indicator region prior to the application of the activation action; and
a second plurality of microcapsules disposed in the second reservoir, each microcapsule of the second plurality of microcapsules including a second payload microencapsulated in a second frangible shell;
wherein the second payload includes a second liquefiable material configured to liquefy responsive to a second predetermined environmental exposure,
wherein the second frangible shells are configured to rupture responsive to the application of the activation action, releasing the second payload from the second frangible shells, and
wherein the second payload is configured to produce a second observable effect in a second indicator region after the second payload is released from the second frangible shells and when the second liquefiable material is liquefied,
wherein the second frangible shells are configured to block the second payload from producing the second observable effect in the second indicator region prior to the application of the activation action.

2. The activatable environmental exposure indicator of claim 1, wherein at least one of one of:
a) the first indicator region is connected to the first reservoir by a first migration region, configured to permit migration of the first payload from the first reservoir to the first indicator region when the first payload is released from the first frangible shells and the first liquefiable material is liquefied, and
b) the second indicator region is connected to the second reservoir by a second migration region configured to permit migration of the second payload from the second reservoir to the second indicator region when the second payload is released from the second frangible shells and the second liquefiable material is liquefied.

3. The activatable environmental exposure indicator of claim 2, wherein at least one of the first migration region and the second migration region comprises a wick.

4. The activatable environmental exposure indicator of claim 2, wherein the cover layer includes transparent portions, configured such that at least the first indicator region and the second indicator region are viewable through the cover layer.

5. The activatable environmental exposure indicator of claim 4, wherein the transparent portions are further configured such that at least a portion of at least one of the first migration region and the second migration region is viewable through the cover layer.

6. The activatable environmental exposure indicator of claim 2, wherein at least one of:
a) the first predetermined environmental exposure is an exposure to a temperature above a first predetermined temperature threshold, such that when the first payload is at a temperature above the first predetermined temperature threshold, the first liquefiable material is liquefied and the first payload migrates through the first migration region at a predetermined rate, and when the first payload is at a temperature below the first predetermined temperature threshold, the first liquefiable material is solidified, and the first payload halts migration through the first migration region, such that a distance through the first migration region which the first payload has migrated corresponds to an amount of time which the first payload has been at temperatures above the first predetermined temperature threshold; and
b) the second predetermined environmental exposure is an exposure to a temperature above a second predetermined temperature threshold, such that when the second payload is at a temperature above the second predetermined temperature threshold, the second liquefiable material is liquefied and the second payload migrates through the second migration region at a predetermined rate, and when the second payload is at a temperature below the second predetermined temperature threshold, the second liquefiable material is solidified, and the second payload halts migration through the second migration region, such that a distance through the second migration region which the second payload has migrated corresponds to an amount of time which the second payload has been at temperatures above the second predetermined temperature threshold.

7. The activatable environmental exposure indicator of claim 1, wherein at least one of one of:
a) the first payload is configured to migrate into the first indicator region and produce the first observable effect responsive to a single exposure to the first predetermined environmental exposure occurring after the first frangible shells are ruptured responsive to the application of the activation action, and
b) the second payload is configured to migrate into the second indicator region and produce the second observable effect responsive to a single exposure to the second predetermined environmental exposure occurring after the second frangible shells are ruptured responsive to the application of the activation action.

8. The activatable environmental exposure indicator of claim 1, wherein at least one of the substrate and the cover defines the first indicator region.

9. The activatable environmental exposure indicator of claim 1, wherein the first reservoir and the second reservoir are sealed between the substrate and the cover layer.

10. The activatable environmental exposure indicator of claim 1, wherein the first plurality of microcapsules and the second plurality of microcapsules are isolated from one another by a membrane, the membrane configured to isolate the first payload from the second payload when the first payload is released from the first frangible shells and second payload is released from the second frangible shells.

11. The activatable environmental exposure indicator of claim 10, wherein the first reservoir is between the substrate and the membrane, and the second reservoir is between the membrane and a cover layer.

12. The activatable environmental exposure indicator of claim 10, wherein the first reservoir is disposed on the substrate, and the second reservoir is disposed on the substrate adjacent to the first reservoir, and the membrane is disposed between the cover layer and the substrate in a configuration which isolates the first reservoir from the second reservoir.

13. The activatable environmental exposure indicator of claim 11, wherein the activation region comprises a depressible portion aligned with both the first reservoir and the second reservoir.

14. The activatable environmental exposure indicator of claim 13, wherein the depressible portion is configured to transfer a compressive force to the first plurality of microcapsules and the second plurality of microcapsules such that at least a proportion of the first frangible shells are ruptured, releasing the first payload, and at least a proportion of the second frangible shells are ruptured, releasing the second payload.

15. The activatable environmental exposure indicator of claim 1, wherein the first plurality of microcapsules and the second plurality of microcapsules are configured to rupture in response to a compression force applied to the activation region with a predetermined activation threshold selected from a group consisting of: a compression stress exceeding 0.1 pounds per square inch (psi), a compression stress exceeding 0.5 psi, a compression stress exceeding 1 psi, a compression stress exceeding 2 psi, a compression stress exceeding 5 psi, a compression stress exceeding 10 psi, and a compression stress exceeding 15 psi.

16. The activatable environmental exposure indicator of claim 15, wherein the predetermined activation threshold for the first plurality of microcapsules and the second plurality of microcapsules is reduced in response to an application of heat.

17. The activatable environmental exposure indicator of claim 1, wherein the first predetermined environmental exposure and the second predetermined environmental exposure are selected from a group consisting of: a temperature excursion above a predetermined temperature threshold for at least a predetermined amount of time, temperature excursion below a predetermined temperature for at least a predetermined amount of time, cumulative exposure to temperature over a time period above a predetermined threshold for at least a predetermined amount of time, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, a predetermined electromagnetic exposure, a humidity exposure, an exposure to a humidity level above a predetermined threshold, and an exposure to a humidity level above a predetermined threshold for at least a predetermined amount of time.

18. The activatable environmental exposure indicator of claim 1, wherein the first liquefiable material and the second liquefiable material comprise materials selected from a group consisting of: a side-chain crystallizable polymer, an alkane, a wax, an alkane wax, esters, other polymeric materials, and combinations thereof.

19. The activatable environmental exposure indicator of claim 1, wherein at least one of:
a) the first payload includes a first indicator material combined with the first liquefiable material; the first indicator material configured to produce the first observable effect in the first indicator region responsive to the first liquefiable material liquefying after the first payload is released from the first frangible shells, and
b) the second payload includes a second indicator material combined with the second liquefiable material; the second indicator material configured to produce the second observable effect in the second indicator region responsive to the second liquefiable material liquefying after the second payload is released from the second frangible shells.

20. The activatable environmental exposure indicator of claim 1, wherein the first predetermined environmental exposure is an exposure to a temperature above a first predetermined high temperature threshold, and the second predetermined environmental exposure is an exposure to a temperature above a second predetermined high temperature threshold, lower than the first predetermined high temperature threshold.

21. A thermal exposure indicator, comprising:
a substrate;
a high temperature excursion indicator coupled to the substrate, comprising:
an indicator region;
a first plurality of microcapsules, each containing a first payload microencapsulated in a first frangible shell, the first payload including a first liquefiable material configured to liquefy when exposed to a temperature above a first predetermined high temperature threshold,
wherein the first frangible shells are configured to rupture responsive to an application of an activation action, releasing the first payload, and
wherein, after being released from the first frangible shells, the first payload is configured to produce an observable effect in the indicator region when liquefied,
wherein, prior to the application of the activation action, the first frangible shells are configured to contain the first payload when the first liquefiable material is liquefied and when the first liquefiable material is not liquefied, such that the first payload is blocked from producing the observable effect in the indicator region even after an exposure to the temperature above the first predetermined high temperature threshold;
a time-temperature indicator, coupled to the substrate comprising:
a migration region; and
a second plurality of microcapsules, each containing a second payload microencapsulated in a second frangible shell, the second payload including a second liquefiable material configured to liquefy when exposed to a temperature above a second predetermined high temperature threshold, and solidify when exposed to a temperature below the second predetermined high temperature threshold,
wherein the second frangible shells are configured to rupture responsive to the application of the activation action, releasing the second payload, and
wherein, after being released from the second frangible shells, the second payload is configured to migrate through the migration region when the second liquefiable material is liquefied, and to halt migration when the second liquefiable material is solidified,
wherein, prior to the application of the activation action, the second frangible shells are configured to contain the second payload when the second liquefiable material is liquefied and when the second liquefiable material solidified, such that the second payload is blocked from migrating through the migration region even after an exposure to the temperature above the second predetermined high temperature threshold; and
an activation region aligned with the first plurality of microcapsules and the second plurality of microcapsules, configured such that when a compressive force is applied to the activation region, the activation action is simultaneously applied to both the first plurality of microcapsules and the second plurality of microcapsules.

22. The thermal exposure indicator of claim 21, wherein the second payload and the migration region are configured such that the second payload migrates at a predetermined rate along the migration region when the second liquefiable material is liquefied, such that a distance along the migration region through which the second payload has migrated corresponds to a cumulative duration of an exposures above the second predetermined high temperature threshold.

23. The thermal exposure indicator of claim 21, wherein the first predetermined high temperature threshold is greater than the second predetermined high temperature threshold.

24. The thermal exposure indicator of claim 21, wherein the activation action includes a compression stress with a predetermined activation threshold selected from a group consisting of: a stress exceeding 0.1 pounds per square inch (psi) a stress exceeding 0.5 psi, a stress exceeding 1 psi, a stress exceeding 2 psi, a stress exceeding 5 psi, a stress exceeding 10 psi, and a stress exceeding 15 psi.

25. The thermal exposure indicator of claim 21, wherein the activation region comprises a depressible portion configured such that when the depressible portion is depressed by the compressive force, the depressible portion transfers a compressive stress to the first plurality of microcapsules and the second plurality of microcapsules.

26. The thermal exposure indicator of claim 21, wherein the first plurality of microcapsules is physically isolated from the second plurality of microcapsules by a membrane, such that when the first plurality of microcapsules is ruptured and the second plurality of microcapsules is ruptured, the first payload is blocked from contacting the migration region and the second payload is blocked from contacting the indicator region.
